(19) United States
(12) Patent Application Publication
(10) Pub. No.: US 2018/0234047 A1
(43) Pub. Date: Aug. 16, 2018

(54) SOLAR TRACKING DEVICE

(71) Applicants: Tzu WANG, Taoyuan County (TW); Pie-Jung WANG, Taoyuan County (TW)

(72) Inventor: Tzu WANG, Taoyuan County (TW)

(21) Appl. No.: 15/430,534

(22) Filed: Feb. 12, 2017

(51) Int. Cl. H02S 20/32; H02S 30/10; F24J 2/54

(52) U.S. Cl. CPC H02S 20/32; H02S 30/10; F24J 2002/5437; F24J 2002/5462; F24J 2002/5468; F24J 2/5427

(57) ABSTRACT

A solar tracking device includes a base, a first driving member, a turntable, a translating plate, a second driving member and a solar panel stand. The first driving member includes a first rotary gear. The turntable has an outer gear ring and a track. The outer gear ring is engaged with the first rotary gear to drive the turntable to rotate with respect to the base. The translating plate is accommodated in the track. The second driving member includes a second rotary gear installed at the translating plate and engaged with the track to drive the translating plate to move horizontally along the track. The solar panel stand includes a main frame and first and second link rod frames. The main frame is driven by the first and second link rod frames to adjust the angle of elevation with respect to the translating plate.

### FIELD OF THE INVENTION

This disclosure relates generally to a solar device, and more particularly to a solar tracking device.

### BACKGROUND OF THE INVENTION

With the rise of environmental awareness, green energy without any emission of pollutants and having the advantage of recyclable materials gradually becomes the focus of energy development. Solar energy is one of the green energies, a solar panel is primarily used to absorb solar radiation and convert the solar radiation into electricity or heat.

However, the direction of sunlight changes with time and a fixed solar panel fails to receive the solar radiation effectively. Therefore, it is an important subject for the research and development of solar energy to design a solar tracker that can be moved stably and smoothly and is combined with the solar panel to adjust the angle of sunlight illumination according to the change of sunlight direction.

Therefore, the discloser of this disclosure based on years of experience in the related industry to conduct extensive research, and experiment, and finally provided a feasible and effective solution in accordance with this disclosure to achieve the aforementioned objective.

### SUMMARY OF THE INVENTION

Therefore, it is a primary objective of the present invention to provide a solar tracking device using a first rotary gear to drive and rotate a turntable, and a second rotary gear to drive and horizontally move a translating plate, so that a main frame can be rotated with respect to a base to adjust the angle of elevation, and the solar tracking device has the advantages of stable movement and smooth rotation.

To achieve the aforementioned and other objectives, this disclosure provides a solar tracking device, comprising: a base; a first driving member, installed to the base, and including at least one first rotary gear; a turntable, coupled to the base, and having an outer gear ring outside the turntable and a track inside the turntable, and two inner gear slots being formed on the inner side of the track, and the outer gear ring and the first rotary gear being engaged with each other to drive the turntable to rotate with respect to the base; a translating plate, accommodated in the track; a second driving member, including a plurality of second rotary gears installed on both sides of the translating plate and engaged with the two inner gear slots to drive the translating plate to move horizontally along the track; and a solar panel stand, including a main frame, a first link rod frame, and a second link rod frame, and an end of the main frame being pivotally coupled to the second link rod frame, and an end of the first link rod frame being pivotally coupled to the base and the other end of the first link rod frame being pivotally coupled to the main frame, and the second link rod frame being fixed to the translating plate and moved with the translating plate, so as to drive the main frame to adjust the angle of elevation with respect to the translating plate.

### BRIEF DESCRIPTION OF THE DRAWINGS

FIG. 1 is a perspective view of a solar tracking device of this disclosure;

FIG. 2 is another perspective view of a solar tracking device of this disclosure;

FIG. 3 is a further perspective view of a solar tracking device of this disclosure;

FIG. 4 is a side view of a solar tracking device of this disclosure;

FIG. 5 is a bottom view of a solar tracking device of this disclosure;

FIG. 6 is a partial blowup view of a solar tracking device of this disclosure;

FIG. 7 is another partial blowup view of a solar tracking device of this disclosure;

FIG. 8 is a schematic view of a first using status of a solar tracking device of this disclosure;

FIG. 9 is a schematic view of a second using status of a solar tracking device of this disclosure;

FIG. 10 is a schematic view of a third using status of a solar tracking device of this disclosure;

FIG. 11 is a schematic view of a fourth using status of a solar tracking device of this disclosure;

FIG. 12 is a schematic view of a fifth using status of a solar tracking device of this disclosure; and

FIG. 13 is a schematic view of a sixth using status of a solar tracking device of this disclosure.

### DESCRIPTION OF THE PREFERRED EMBODIMENTS

The technical contents of the present invention will become apparent with the detailed description of preferred embodiments accompanied with the illustration of related drawings as follows. It is noteworthy that the preferred embodiments are provided for illustrating this disclosure rather than restricting the scope of the disclosure.

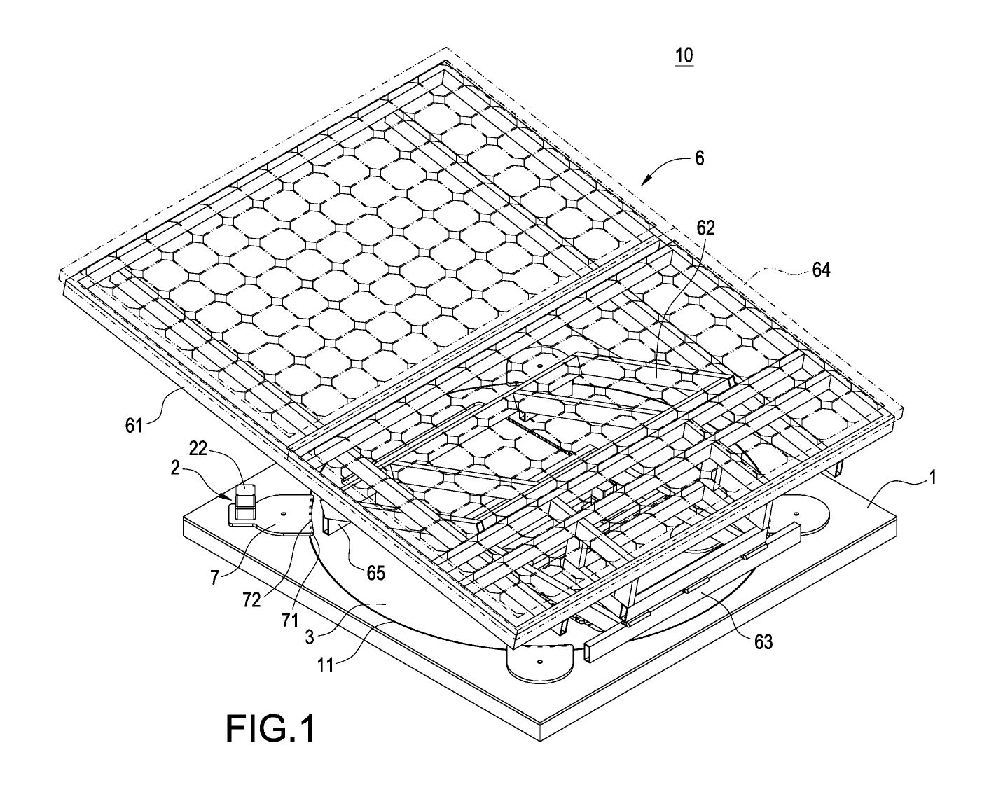

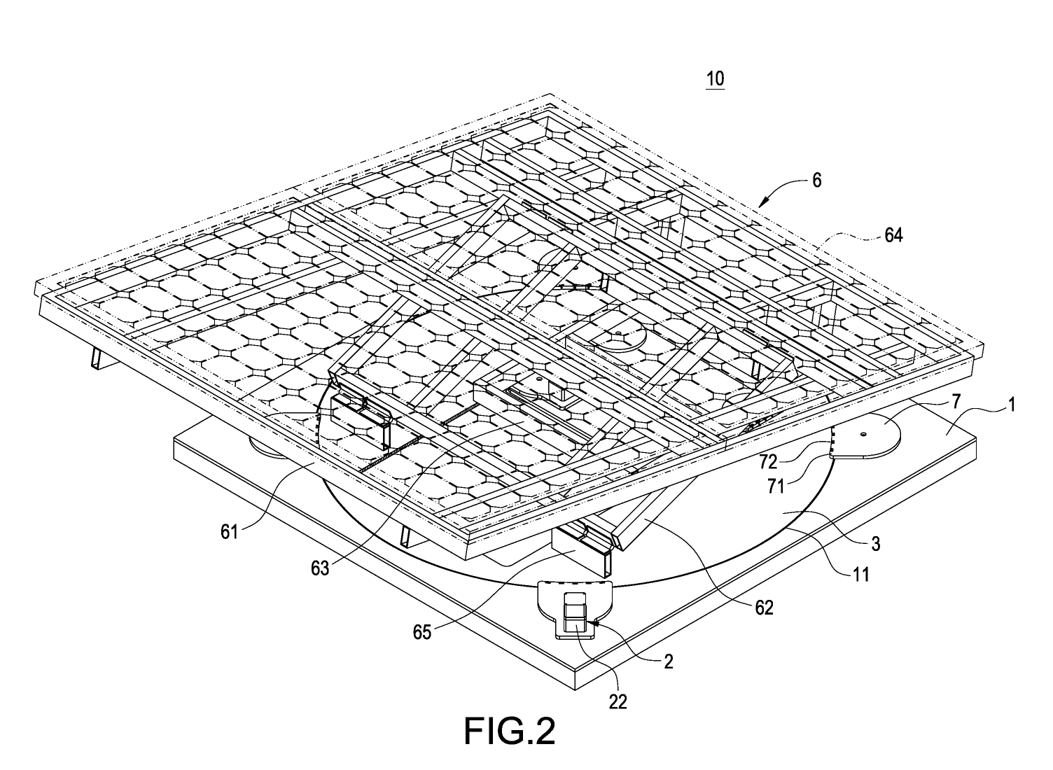

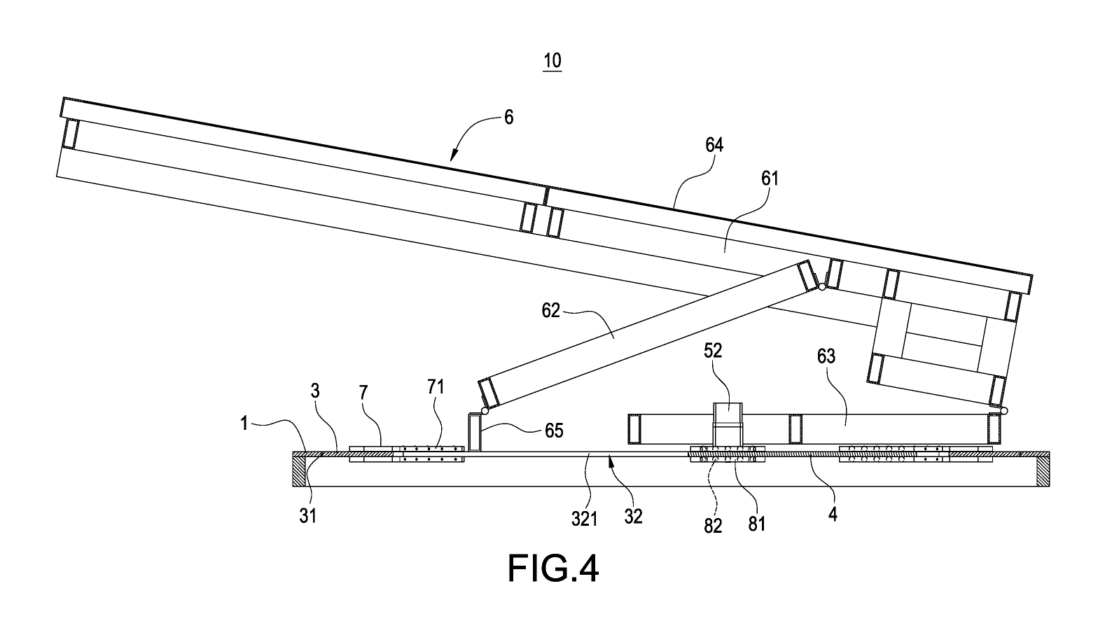

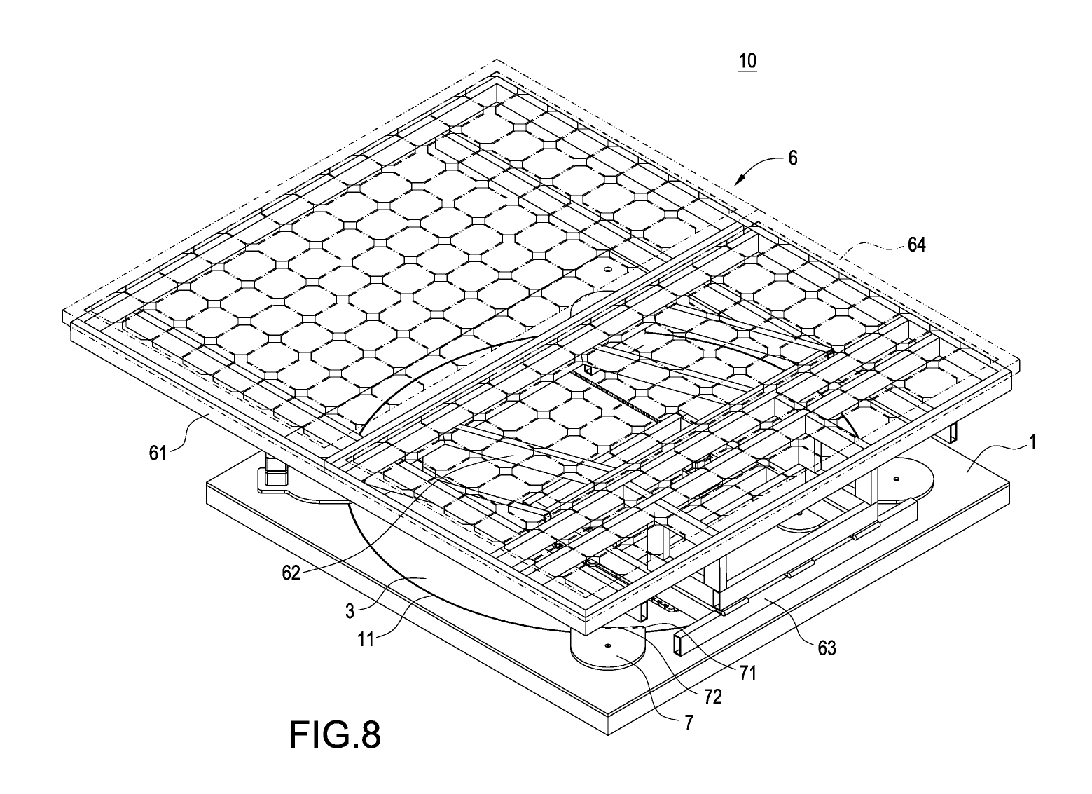

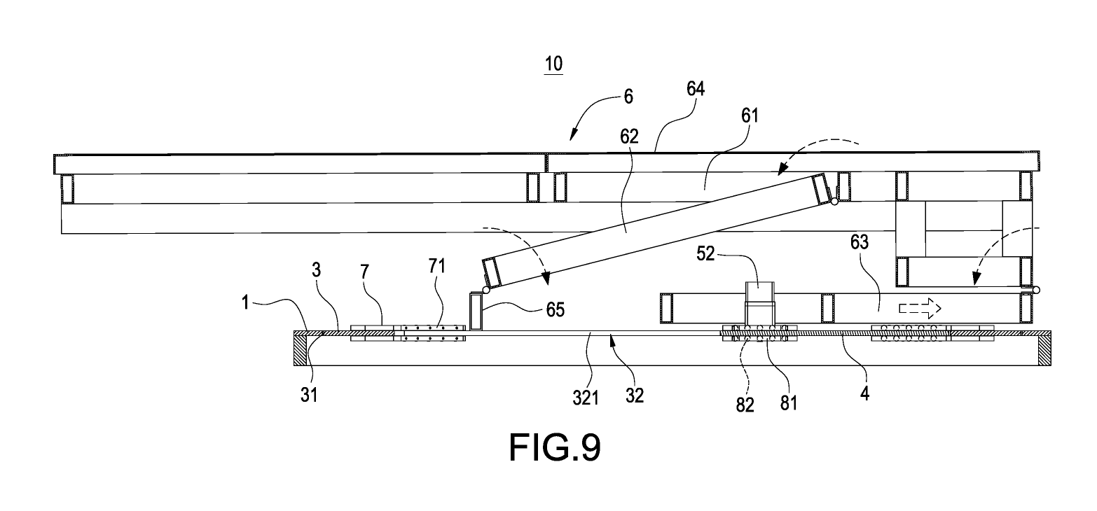

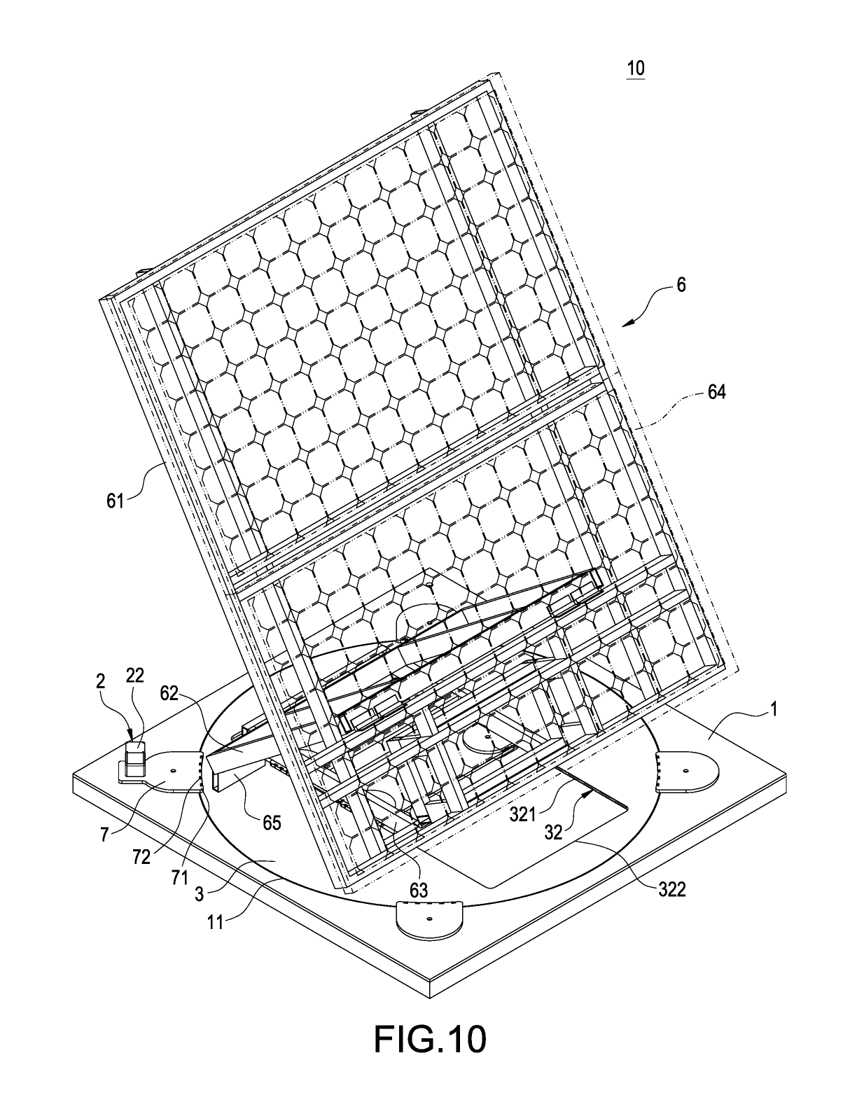

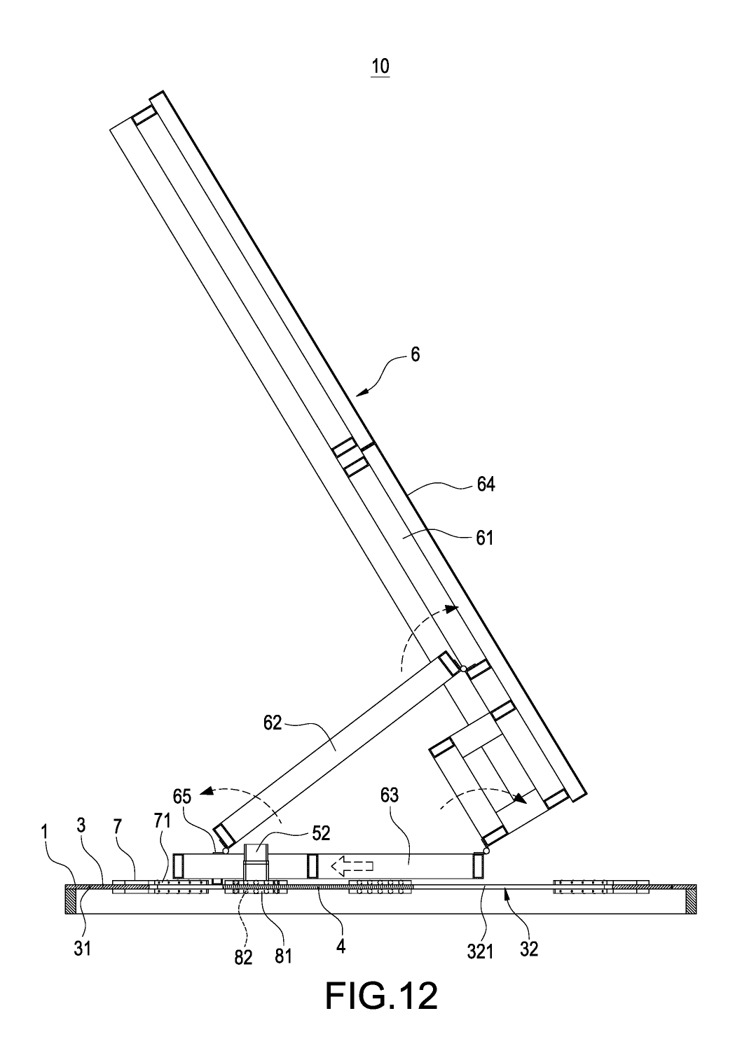

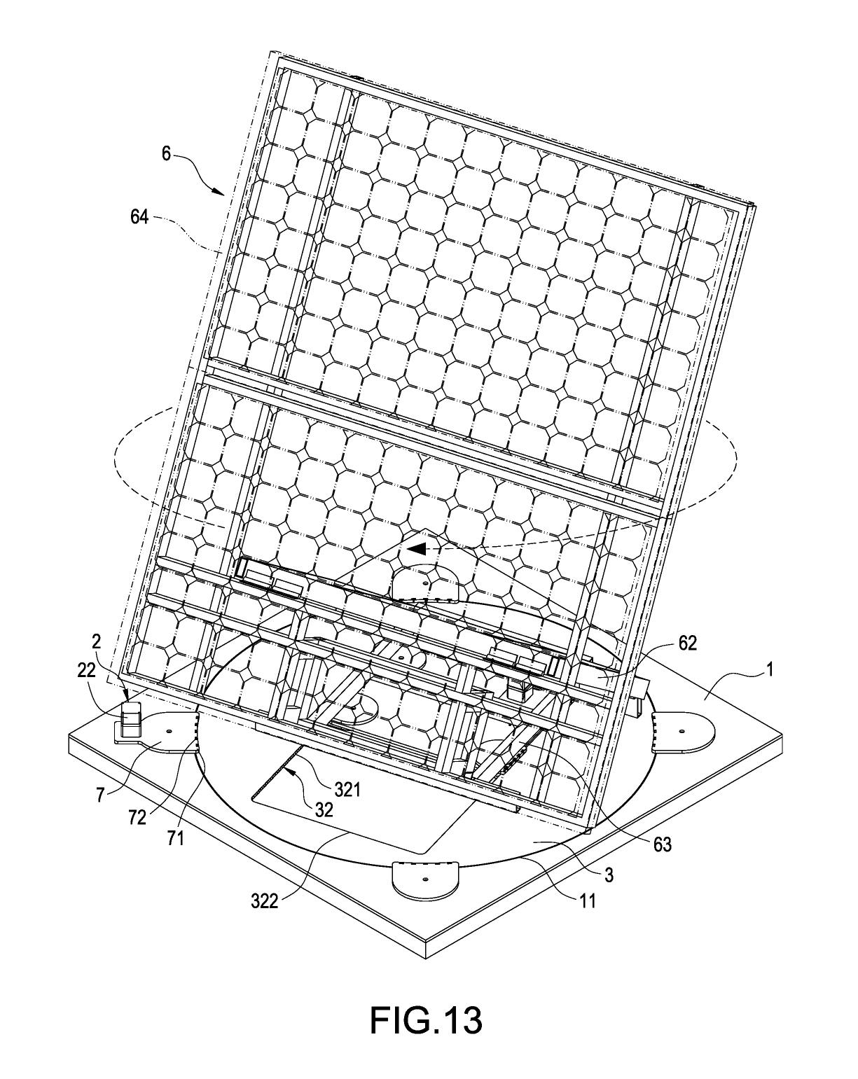

With reference to FIGS. 1 to 13 for a solar tracking device of this disclosure, the solar tracking device 10 comprises a base 1, a first driving member 2, a turntable 3, a translating plate 4, a second driving member 5 and a solar panel stand 6.

In FIGS. 1, 2, 5, 10, 11, and 13, the base 1 has a hollow groove 11, and the first driving member 2 is installed onto the base 1 and includes one or more first rotary gears 21 and a first driving motor 22, and the first driving motor 22 is fixed to the base 1 and has a first output gear 221 engaged with one of the plurality of first rotary gears 21.

In FIGS. 1 to 5 and 8 to 13, the turntable 3 is coupled to the base 1 and the turntable 3 has an outer gear ring 31 outside the turntable 3 and a track 32 inside the turntable 12, and the inner side of the track 32 has two inner gear slots 321, and the outer gear ring 31 and the first rotary gear 21 are engaged with each other to drive the turntable 3 to rotate with respect to the base 1. In this preferred embodiment, the track 32 is a penetrating groove 322 penetrating through the turntable 3, and the two inner gear slots 321 are formed on two opposite inner sides of the penetrating groove 322 respectively.

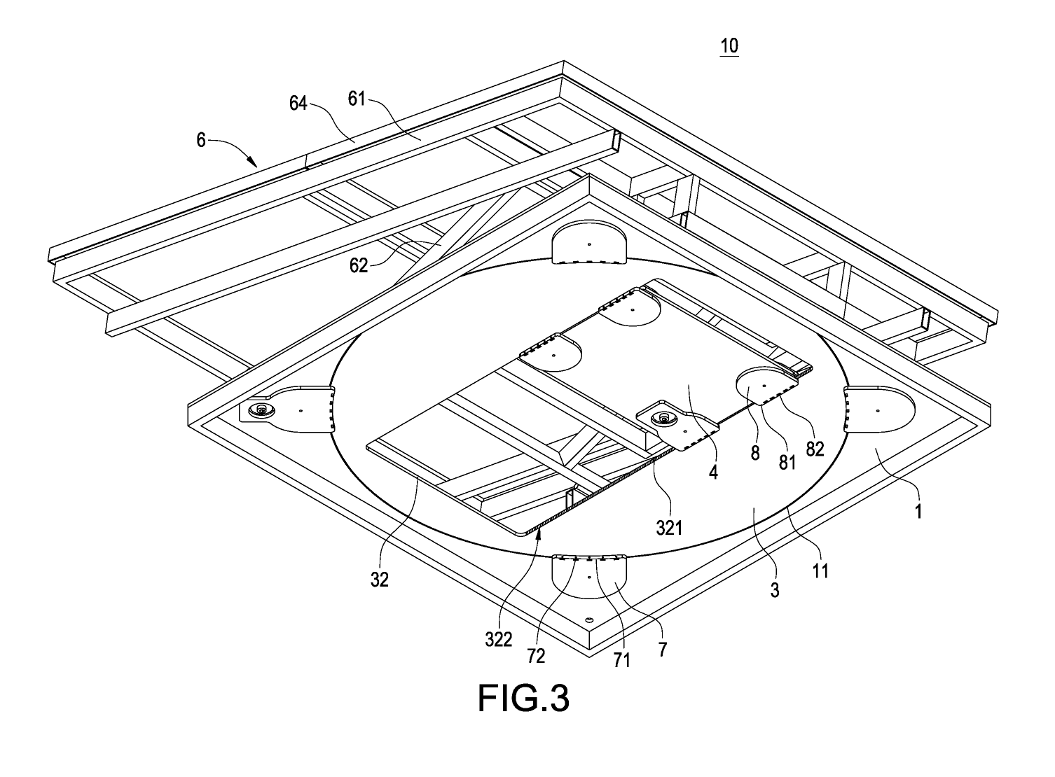

In FIGS. 3 to 5, 7, 9, 11 and 12, the translating plate 4 is accommodated in the track 32. In other words, the translating plate 4 is accommodated in the penetrating groove 322. The second driving member 5 includes a plurality of second rotary gears 51 and a second driving motor 52, and the plurality of second rotary gears 51 are installed on both sides of the translating plate 4 and engaged with the two inner gear slots 321, so as to drive the translating plate 4 to move horizontally along the track 32, and the second driving motor 52 is fixed to the translating plate 4, and the second driving motor 52 has a second output gear 521 engaged with one of the plurality of second rotary gears 51.

In FIGS. 1 to 4 and 8 to 13, the solar panel stand 6 comprises a main frame 61, a first link rod frame 62, a second link rod frame 63, a solar panel 64 and two heightened blocks 65, and an end of the main frame 61 is pivotally coupled to second link rod frame 63 and the first link rod frame 62 has an end pivotally coupled to the base 1 and the other end pivotally coupled to the main frame 61, and the second link rod frame 63 is fixed to the translating plate 4 and moved with the translating plate 4, so as to drive the main frame 61 to adjust the angle of elevation with respect to the translating plate 4.

In addition, the solar panel 64 is installed onto the main frame 61, and the two heightened blocks 65 are fixed to the base 1 and disposed on the outer side of the two inner gear slots 321, and the first link rod frame 62 is pivotally coupled to the two heightened blocks 65, and an interval space s is formed between the first link rod frame 62 and the two heightened blocks 65, and the second link rod frame 63 can be passed and installed in the interval space s.

In FIGS. 1 to 6 and 8 to 13, the solar tracking device 10 of this disclosure further comprises plural pairs of first clips 7, and each pair of first clips 7 is fixed on both sides of the base 1 and configured to be opposite to each other, and the pair of first clips 7 have two first clamping sections 71 protruding to the hollow groove 11, and the quantity of first rotary gears 21 is plural, and each first rotary gear 21 is clamped and pivotally coupled between each pair of first clips 7, and the turntable 3 is clamped between every two of the first clamping sections 71, so that the turntable 3 is securely limited and accommodated in the hollow groove 11. Wherein, each first clamping section 71 has a plurality of first rollers 72 abutting the turntable 3, so that the turntable 3 can be rotated smoothly with respect to the base 1.

In FIGS. 3 to 5, 7, 9, 11 and 12, the solar tracking device 10 of this disclosure further comprises plural pairs of second clips 8, and the pair of second clips 8 are fixed on both sides of the translating plate 4 and configured to be opposite to each other, and each pair of second clips 8 have two second clamping sections 81 protruding to the turntable 3, and each second rotary gear 51 is clamped and pivotally coupled between each pair of second clips 8, and the turntable 3 is clamped between every two second clamping sections 81, so that the translating plate 4 is securely limited and accommodated in the penetrating groove 322. Wherein, each second clamping section 81 has a plurality of second rollers 82 abutting the turntable 3, so that the translating plate 4 can be moved horizontally along the track 32 more smoothly.

In FIGS. 1 to 7, the assembly of the solar tracking device 10 of this disclosure installs the first driving member 2 in the base 1, and the first driving member 2 comprises a first rotary gear 21; and the turntable 3 is coupled to the base 1, and turntable 3 has an outer gear ring 31 outside the turntable 3 and a track 32 inside the turntable 3, and the inner side of the track 32 has an inner gear slot 321, and the outer gear ring 31 and the first rotary gear 21 are engaged with each other, so as to drive the turntable 3 to rotate with respect to the base 1; and the translating plate 4 is accommodated in the track 32. The second driving member 5 includes a second rotary gear 51 installed on both sides of the translating plate 4 and engaged with the inner gear slot 321, so as to drive the translating plate 4 to move horizontally along the track 32. The solar panel stand 6 includes a main frame 61, a first link rod frame 62 and a second link rod frame 63, and an end of the main frame 61 is pivotally coupled to second link rod frame 63, and the first link rod frame 62 has an end pivotally coupled to base 1 and the other end pivotally coupled to main frame 61, and the second link rod frame 63 is fixed to the translating plate 4 and moved with the translating plate 4, so as to drive the main frame 61 to adjust the angle of elevation with respect to the translating plate 4. The first rotary gear 21 drives the turntable 3 to rotate, and the second rotary gear 51 drives the translating plate 4 to move horizontally, so that the main frame 61 can be rotated with respect to the base 1 and the angle of elevation can be adjusted, and the solar tracking device 10 has the advantages of stable movement and smooth rotation.

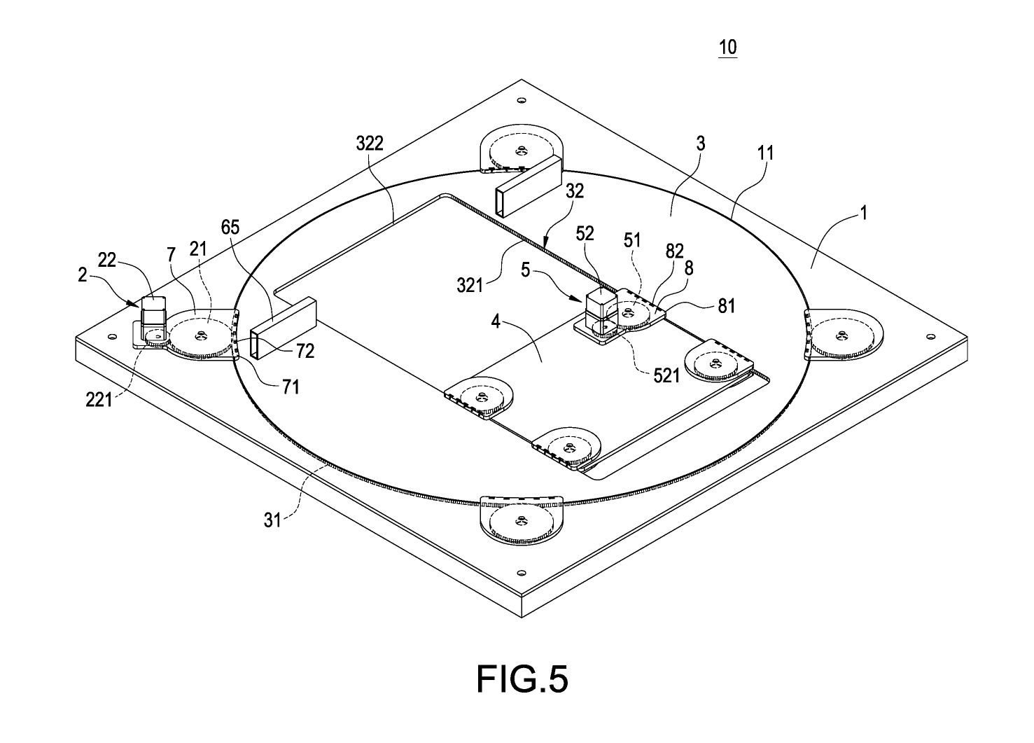

With reference with FIGS. 5 to 13 for different using statuses of the solar tracking device 10 of this disclosure, FIGS. 5 and 7 to 12 show that the second output gear 521 of the second driving motor 52 is engaged to drive one of the second rotary gears 51, and the second rotary gear 51 engaged by the second output gear 521 is further engaged with the inner gear slot 321 of the track 32, so that the translating plate 4 can be moved horizontally along the track 32, and then an end of the first link rod frame 62 is pivotally coupled to the base 1 and the other end of the first link rod frame 62 is pivotally coupled to the main frame 61, and the second link rod frame 63 is fixed to the translating plate 4 and moved with the translating plate 4, so as to drive the main frame 61 to adjust the angle of elevation with respect to the translating plate 4. Therefore, the solar tracking device 10 has the effect of adjusting the angle of elevation of the solar panel 64 stably and smoothly.

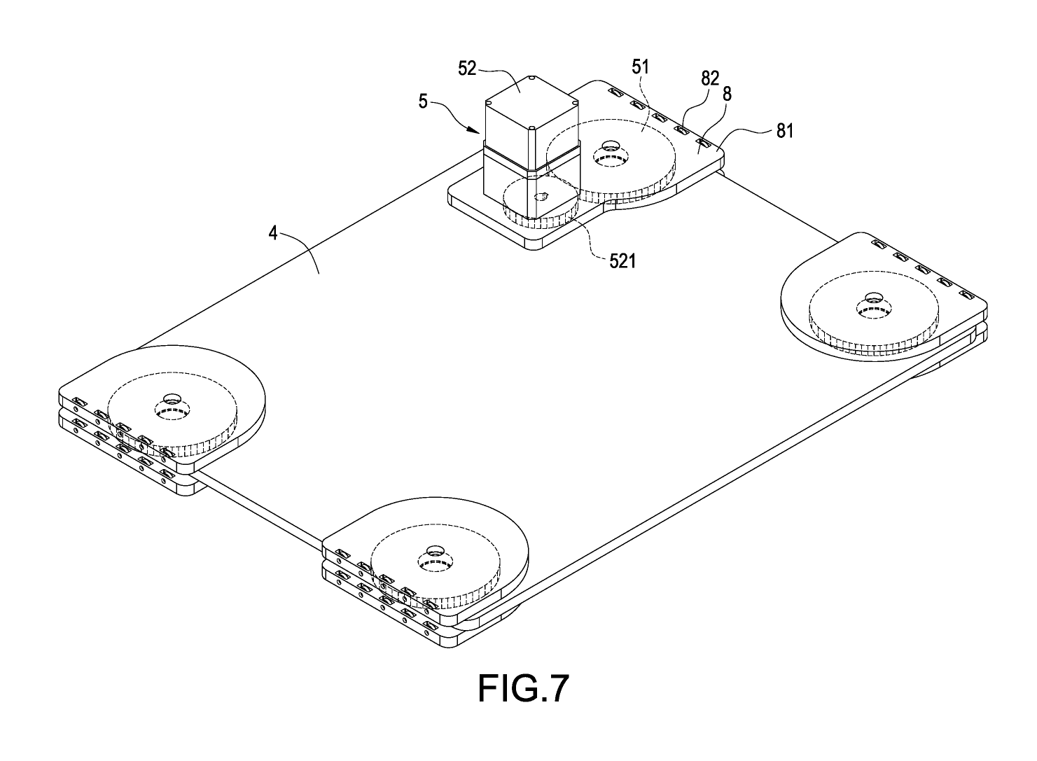

In FIGS. 5 and 7, the second output gear 521 is just engaged to drive one of the second rotary gears 51, and the remaining second rotary gears 5 not engaged and driven by the second output gear 521 are mainly used for engaging the corresponding inner gear slots 321, so as to stably and uniformly disperse the action force produced by the movement of the translating plate 4 and allow the translating plate 4 to slide in the track 32 stably and smoothly.

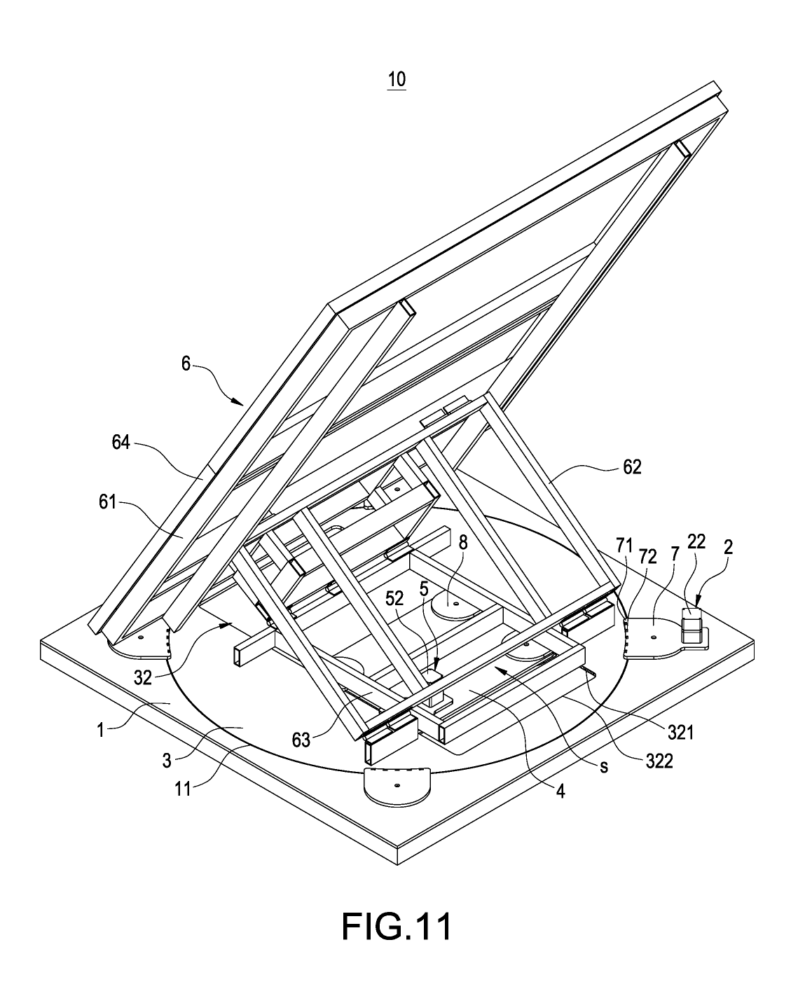

In FIG. 11, an interval space s is formed between the first link rod frame 62 and the two heightened blocks 65, and the second link rod frame 63 can be passed and installed in the interval space s, so that the moving path of the second link rod frame 63 and the translating plate 4 can be shared with the installation space of the first link rod frame 62 in order to reduce the space of installing the components. Therefore, the solar tracking device 10 has the features of installing the components and reducing the overall volume effectively.

In FIGS. 5, 6, 12 and 13, the first output gear 221 of the first driving motor 22 is engaged to drive one of the first rotary gears 21, and the first rotary gear 21 engaged by the first output gear 221 is further engaged with the outer gear ring 31 of the turntable 3, so that the turntable 3 can be rotated with respect to the base 1, and the main frame 61 of the turntable 3 also can be rotated with respect to the base 1, and the solar tracking device 10 has the effect of rotating the solar panel 64 stably and smoothly.

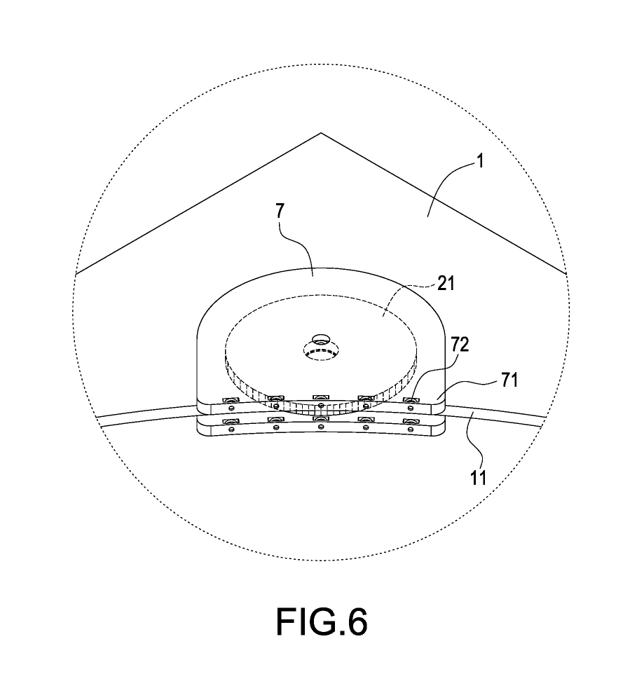

In FIGS. 5 and 6, the first output gear 221 is just engaged to drive one of the first rotary gears 21, and the remaining first rotary gear 21 not engaged with the first output gear 221 are mainly used for engaging the periphery of the turntable 3, so as to stably and uniformly disperse the action force produced by the turntable 3. Therefore, the turntable 3 can be rotated with respect to the base 1 more stably and smoothly.

In summation of the description above, this disclosure achieves the expected effects, overcomes the drawbacks of the prior art, and complies with the patent application requirements, and thus is duly filed for patent application. While the invention has been described by means of specific embodiments, numerous modifications and variations could be made thereto by those skilled in the art without departing from the scope and spirit of the invention set forth in the claims.

What is claimed is:

1. A solar tracking device, comprising:
a base;
a first driving member, installed to the base, and including at least one first rotary gear;
a turntable, coupled to the base, and having an outer gear ring outside the turntable and a track inside the turntable, and two inner gear slots being formed on an inner side of the track, and the outer gear ring and the at least one first rotary gear being engaged with each other to drive the turntable to rotate with respect to the base;
a translating plate, accommodated in the track;
a second driving member, including a plurality of second rotary gears installed on both sides of the translating plate and engaged with the two inner gear slots to drive the translating plate to move horizontally along the track; and
a solar panel stand, including a main frame, a first link rod frame, and a second link rod frame, and an end of the main frame being pivotally coupled to the second link rod frame, and an end of the first link rod frame being pivotally coupled to the base and the other end of the first link rod frame being pivotally coupled to the main frame, and the second link rod frame being fixed to the translating plate and moved with the translating plate, so as to drive the main frame to adjust an angle of elevation with respect to the translating plate.

2. The solar tracking device of claim 1, further comprising plural pairs of first clips, and the base having a hollow groove, and each pair of the first clips being fixed to the base and configured to be opposite to each other, and each pair of first clips having two first clamping sections protruding to the hollow groove, and there a plurality of first rotary gears, and each of the first rotary gears being clamped and pivotally coupled between each pair of the first clips, and the turntable being accommodated in the hollow groove and clamped between every two of the first clamping sections.

3. The solar tracking device of claim 2, wherein each of the first clamping sections has a plurality of first rollers abutting the turntable.

4. The solar tracking device of claim 2, wherein the first driving member further comprises a first driving motor fixed to the base, and the first driving motor has a first output gear engaged with one of the plurality of first rotary gears.

5. The solar tracking device of claim 2, further comprising plural pairs of second clips, and the track being a penetrating groove penetrating through the turntable, and the two inner gear slots being formed on two opposite inner sides of the penetrating groove respectively, and the translating plate being accommodated in the penetrating groove, each pair of second clips being fixed to both sides of the translating plate and configured to be opposite to each other, and each pair of second clips having two second clamping sections protruding to the turntable, and each second rotary gear being clamped and pivotally coupled between each pair of second clips, and the turntable being clamped between every two of the second clamping sections.

6. The solar tracking device of claim 5, wherein each of the second clamping sections has plurality of second rollers abutting the turntable.

7. The solar tracking device of claim 5, wherein the second driving member further comprises a second driving motor fixed to the translating plate, and the second driving motor has a second output gear engaged with one of the plurality of second rotary gears.

8. The solar tracking device of claim 5, wherein the solar panel stand further comprises two heightened blocks fixed to the base disposed on an outer side of the two inner gear slots, and the first link rod frame being pivotally coupled to the two heightened blocks, and an interval space being formed between the first link rod frame and the two heightened blocks, and the second link rod frame being passed and installed into the interval space.

9. The solar tracking device of claim 5, wherein the solar panel stand further includes a solar panel mounted onto the main frame.
